(19) United States
(12) Patent Application Publication
(10) Pub. No.: US 2006/0126356 A1
(43) Pub. Date: Jun. 15, 2006

(54) Light-transmission structure and light-transmission device incorporating the same

(76) Inventors: Chi-Tsung Peng, Hsinchu (TW); Chien-Shun Chen, Yunlin (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/191,869

(22) Filed: Jul. 27, 2005

(30) Foreign Application Priority Data
Dec. 14, 2004 (TW) 93220106

(51) Int. Cl. G02B 6/00

(52) U.S. Cl. 362/551

(57) ABSTRACT

A light-transmission structure includes a linear light-transmission body and a sheet structure protruding from the periphery of the linear light-transmission body. The sheet structure and the linear light-transmission body are integrally formed as one piece, and the light-transmission structure is fixed on an object to be decorated through the connection of the sheet structure and the object to be decorated.

### BACKGROUND OF THE INVENTION

a. Field of the Invention

The invention relates to a light-transmission structure and a light transmission device that is combined with an object to be decorated.

b. Description of the Related Art

Conventional efforts are being made to provide enhanced visibility or illumination for an object to be decorated such as clothes under the circumstance of darkness. For example, a powered light-transmission device is developed, which may be mounted on the clothes to provide enhanced illumination that functions as an alarm in darkness.

FIG. 1A shows a schematic view illustrating a conventional combination of a light-transmission wire and a textile. FIG. 1B is a cross-section cut along A-A line in FIG. 1A. Referring to FIGS. 1A and 1B, according to the conventional design, a transparent front plate 102 and a rear plate 104 are needed to enclose and position the light-transmission wire 100, and the three elements 100, 102 and 104 joined together are then sewed or glued on the textile. However, in such design, three different molds are needed to respectively form the front plate 102, the rear plate 104 and the light-transmission wire 100 to result in a complicated manufacturing process and a high cost. Further, after the front plate 102 and rear plate 104 enclose and position the light-transmission wire 100, such assembly is hard to change in shape to match the shape of the object to be decorated.

### BRIEF SUMMERY OF THE INVENTION

An object of the invention is to provide a light-transmission device whose shape is easy to be changed in accordance with the figure of objects to be decorated.

Another object of the invention is to provide a light-transmission device that is easy to be combined with the objects to be decorated.

According to the design of the invention, a light-transmission structure includes a linear light-transmission body and a sheet structure protruding from the periphery of the linear light-transmission body. The sheet structure and the linear light-transmission body are integrally formed as one piece, and the light-transmission structure is fixed on an object to be decorated through the connection of the sheet structure and the object to be decorated.

Through the design of the invention, because the linear light-transmission body and the sheet structure are integrally formed as one piece, the manufacturing process is quite simple, and they altogether can be bent into different shapes to match the shape of the object to be decorated. When the sheet structure is fixed on the object to be decorated, the light-transmission structure is directly mounted on the object without the need of the front and back plates as mentioned in the conventional method. Hence, the connection process regarding the light-transmission structure and the object to be decorated is simplified, and the manufacturing cost is reduced as a result.

### BRIEF DESCRIPTION OF THE DRAWINGS

FIG. 1A shows a schematic view illustrating a conventional combination of a light-transmission wire and a textile.

FIG. 1B shows a cross-section cut along A-A line in FIG. 1A.

FIG. 2 is a schematic diagram illustrating a light-transmission device according to an embodiment of the invention.

FIG. 3 shows an embodiment relating the combination of a light-transmission structure and a textile product.

FIG. 4 shows a schematic diagram illustrating another embodiment relating the combination of a light-transmission structure and a textile product.

FIG. 5 shows a schematic diagram illustrating an embodiment of the light-transmission structure according to the invention.

FIG. 6 shows a schematic diagram illustrating another embodiment of the light-transmission structure according to the invention.

FIG. 7 shows a schematic diagram illustrating another embodiment of the light-transmission structure according to the invention.

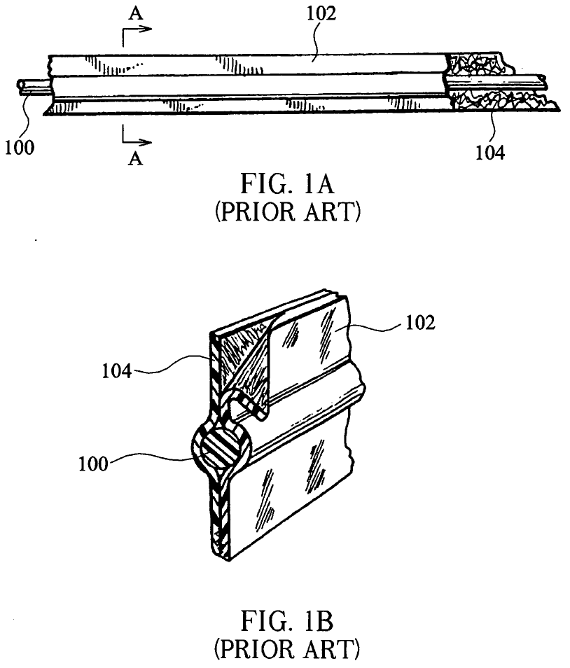

### DETAILED DESCRIPTION OF THE INVENTION

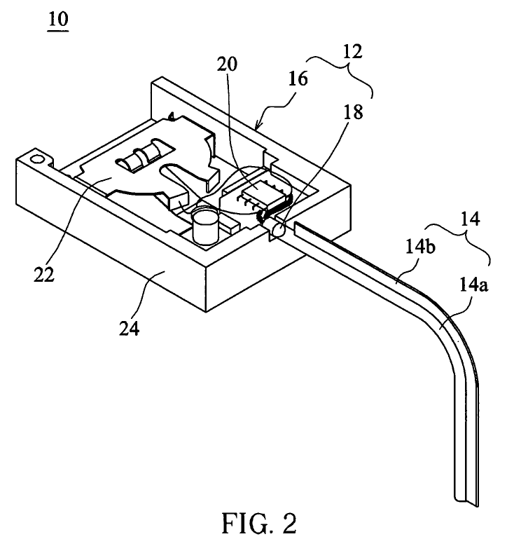

FIG. 2 is a schematic diagram illustrating a light-transmission device 10 according to an embodiment of the invention.

Referring to FIG. 2, the light-transmission device 10 includes a light source 12 and a flexible light-transmission structure 14. According to this embodiment, the light source 12 includes a light-producing unit 16 and an illuminant such as a light emitting diode (LED) 18. The light-producing unit 16, which is used for controlling the emitting light of the LED 18, includes a circuit 20, a battery holder 22, and a casing 24 for receiving the circuit 20 and the battery holder 22. The light-transmission structure 14 includes a linear light-transmission body 14a and a sheet structure 14b protruding from the periphery of the linear light-transmission body 14a. The light-transmission structure 14 is made of a flexible plastic wire, and the linear light-transmission body 14a is in a cylindrical shape.

According to the invention, the linear light-transmission body 14a and the sheet structure 14b are integrally formed as one piece by injection molding. The light-transmission structure 14 can be bent into different shapes and its transparency allows for radiating light received from the light source 12.

When the light-producing unit 16 is enabled to turn on the LED 18, the light-transmission structure 14 receives the light from the LED 18 and radiates the light evenly to the outside. Hence, the flexible plastic wire becomes a strip-like illuminant and can be bent into different shapes due to its flexibility to match the shape of an object to be decorated. Besides, as the light-transmission structure 14 is incorporated into the object to be decorated, the sheet structure 14b protruding from the periphery of the linear light-transmission body 14a serves as a connection part to have the connection process more easily.

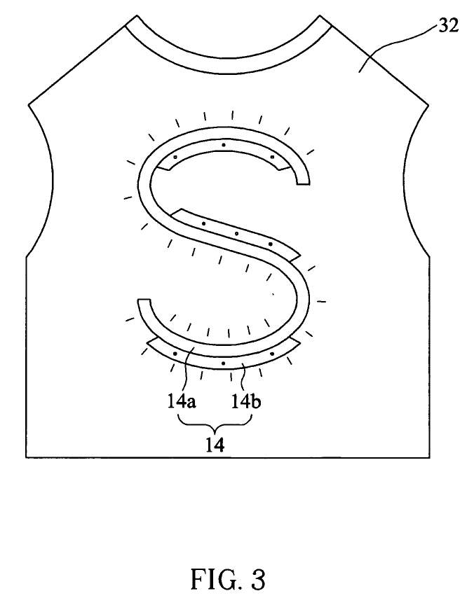

Referring to FIG. 3, there is shown an embodiment relating the combination of the light-transmission structure 14 and a textile product such as clothes 32. Since the light-transmission structure 14 includes the sheet structure 14b functioning as the connection part, the linear light-transmission body 14a of the light-transmission structure 14 is directly mounted on the clothes 32 as the sheet structure 14b is sewed on the clothes 32.

Through the design of the invention, because the linear light-transmission body 14a and the sheet structure 14b are integrally formed as one piece, the manufacturing process is quite simple, and they altogether can be bent into different shapes to match the shape of the object to be decorated. When the sheet structure 14b is fixed on the object to be decorated, such as by means of sewing, the light-transmission structure 14 is directly mounted on the object without the need of the front and back plates as mentioned in the conventional method. Hence, the connection process regarding the light-transmission structure 14 and the object to be decorated is simplified, and the manufacturing cost is reduced as a result.

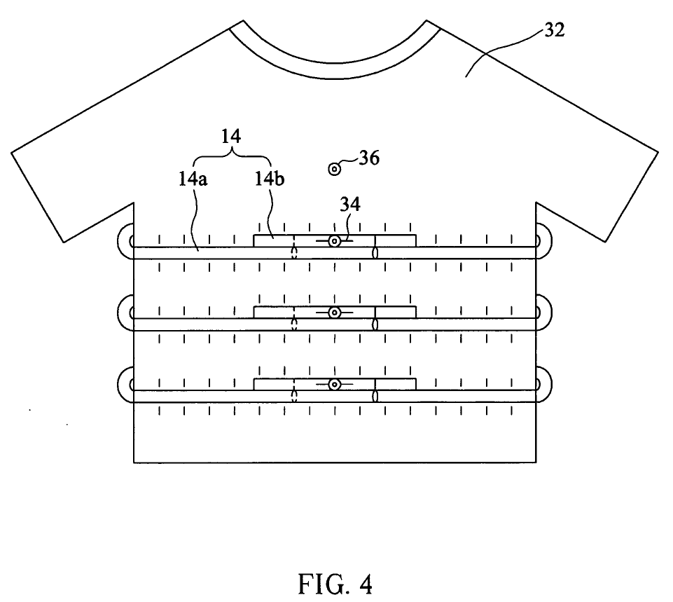

FIG. 4 shows a schematic diagram illustrating another embodiment relating the combination of the light-transmission structure 14 and a textile product such as clothes 32. Referring to FIG. 4, the sheet structure 14b may be sliced to form a plurality of slits 34. After the linear light-transmission body 14a is wrapped on the clothes 32, the buttons 36 on the clothes 32 are inserted in the slits 34 to fasten the whole light-transmission structure 14 to the clothes 32. Further, the clothes 32 may be provided with multiple light-transmission structures 14 wrapped thereon to enhance the overall brightness.

Hence, since the sheet structure 14b can be directly sewed or buckled on the object to be decorated, the connection process regarding the light-transmission structure 14 and the object to be decorated is simplified.

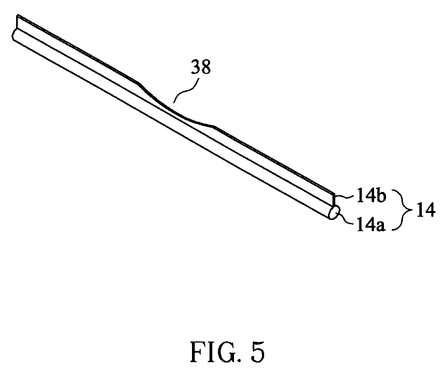

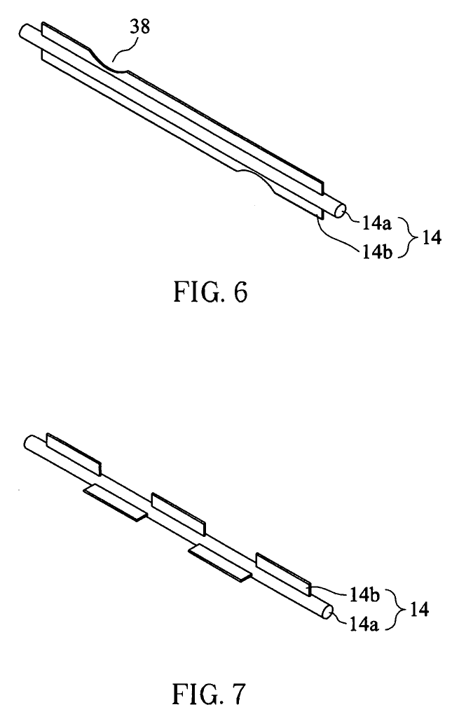

Further, the sheet structure 14b merely functions as a connection part, and its position and formation are not limited. Referring to FIG. 5, the sheet structure 14b may be continuously distributed on the linear light-transmission body 14a and provided with a notch 38. Hence, when the light-transmission structure 14 is bent to conform to a specific shape, the notch 38 serves to provide clearance during compression or extension so that the sheet structure 14b may be easily attached on the object to be decorated without wrinkles. Alternatively, referring to FIG. 6, multiple lines of sheet structure 14b may be provided on the linear light-transmission body 14a, with each line being provided with a notch 38. Further, the sheet structure 14b may be divided into separate sections on the linear light-transmission body 14a, and the separate sections may extend along different directions, making an angle with each other as shown in FIG. 7.

The light-transmission structure is made of a thermoplastic material with flexibility and high transparency, such as polycarbonate, polystyrene, polymethyl methacrylate, MMA styrene copolymer, thermoplastic polyurethane, and ethylene vinyl acetate. Further, the light-transmission structure 14 may be a fiber having side-illumination.

Also, there is no limitation on the selection of the illuminant, as long as the input light efficiency is good; for example, the LED shown in FIG. 2 or a typical light bulb may be used.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A light-transmission structure, which is used for receiving and radiating the emitting light of a light source, comprising:
a linear light-transmission body; and
a sheet structure protruding from the periphery of the linear light-transmission body;
wherein the sheet structure and the linear light-transmission body are integrally formed as one piece, and the light-transmission structure is mounted on an object to be decorated through the connection of the sheet structure and the object to be decorated.

2. The light-transmission structure as claimed in claim 1, wherein the linear light-transmission body is in a cylindrical shape.

3. The light-transmission structure as claimed in claim 1, wherein the sheet structure is continuously distributed on the linear light-transmission body.

4. The light-transmission structure as claimed in claim 1, wherein the sheet structure includes a plurality of separate sections on the linear light-transmission body.

5. The light-transmission structure as claimed in claim 1, wherein the sheet structure is provided with at least one notch.

6. The light-transmission structure as claimed in claim 1, wherein the sheet structure is sewed on the object to be decorated.

7. The light-transmission structure as claimed in claim 1, wherein the sheet structure is buckled on the object to be decorated.

8. The light-transmission structure as claimed in claim 7, wherein the sheet structure is sliced to form at least one slit.

9. The light-transmission structure as claimed in claim 1, wherein the light-transmission structure is made of a transparent thermoplastic material.

10. The light-transmission structure as claimed in claim 1, wherein the light-transmission structure is made of a fiber having side-illumination.

11. The light-transmission structure as claimed in claim 1, wherein the material of light-transmission structure is selected from the group consisting of polycarbonate, polystyrene, polymethyl methacrylate, MMA styrene copolymer, thermoplastic polyurethane, and ethylene vinyl acetate.

12. The light-transmission structure as claimed in claim 1, wherein the object to be decorated is a textile.

13. A light-transmission device, comprising:
a light source; and
a flexible light-transmission structure positioned adjacent to the light source, the light-transmission structure comprising a linear light-transmission body and a sheet structure protruding from the periphery of the linear light-transmission body, the light-transmission body and the sheet structure being integrally formed as one piece, and the light-transmission structure being mounted on an object to be decorated through the connection of the sheet structure and the object to be decorated.

14. The light-transmission device as claimed in claim 13, wherein the linear light-transmission body is in a cylindrical shape.

15. The light-transmission device as claimed in claim 13, wherein the sheet structure is continuously distributed on the linear light-transmission body.

16. The light-transmission device as claimed in claim 13, wherein the sheet structure includes a plurality of separate sections on the linear light-transmission body.

17. The light-transmission device as claimed in claim 13, wherein the sheet structure is provided with at least one notch.

18. The light-transmission device as claimed in claim 13, wherein the light source comprises at least one illuminant and a light-producing unit for controlling the illuminant.

19. The light-transmission device as claimed in claim 18, wherein the light-producing unit comprises a circuit, a battery holder, and a casing for receiving the circuit and the battery holder.

20. The light-transmission device as claimed in claim 18, wherein the illuminant is a light emitting diode or a light bulb.
